(19) United States
(12) Patent Application Publication
(10) Pub. No.: US 2013/0057475 A1
(43) Pub. Date: Mar. 7, 2013

(54) SPLIT KEYBOARD FOR THUMB TYPING

(71) Applicants: Finbarr Duggan, Dublin (IE); Seung Yang, Woodinville, WA (US); Vasudha Chandrasekaran, Mountain View, CA (US); Jeff Weir, Seattle, WA (US); Dan Odell, Kirkland, WA (US); Moneta Ho Kushner, Bellevue, WA (US); Gerrit Hofmeester, Woodinville, WA (US); John Murphy, Athlone (IE); Gary Sherman, Dublin (IE)

(72) Inventors: Finbarr Duggan, Dublin (IE); Seung Yang, Woodinville, WA (US); Vasudha Chandrasekaran, Mountain View, CA (US); Jeff Weir, Seattle, WA (US); Dan Odell, Kirkland, WA (US); Moneta Ho Kushner, Bellevue, WA (US); Gerrit Hofmeester, Woodinville, WA (US); John Murphy, Athlone (IE); Gary Sherman, Dublin (IE)

(73) Assignee: Microsoft Corporation, Redmond, WA (US)

(21) Appl. No.: 13/223,326

(22) Filed: Sep. 1, 2011

(51) Int. Cl. G06F 3/02

(52) U.S. Cl. 345/168

(57) ABSTRACT

In one embodiment, a split virtual keyboard may be optimized for thumb typing. A processor 120 may determine a virtual key layout for a split virtual keyboard based on a thumb range of a user. A touch screen 502 may display the split virtual keyboard 504 to the user.

### BACKGROUND

The keyboard has long been a standard input device in computing. With more handheld computing devices and computer tablets incorporating touch screens, virtual keyboards may have greater utility. A touch screen is a display that registers the touch of a user through thermal sensing, electrical conductivity, or other techniques. Both standard and virtual keyboards may be arranged in any number of key formations, such as a QWERTY, QWERTZ, or AZERTY design, referencing the first six letters in the upper left corner of the keyboard. A standard virtual keyboard may be displayed at the bottom of the touch screen in a solid block.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to a split virtual keyboard optimized for thumb typing. A processor may determine a virtual key layout for a split virtual keyboard based on a thumb range of a user. A touch screen may display the split virtual keyboard to the user.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a portable computer device.

FIGS. 2A-B illustrate, in block diagrams, embodiments of a standard virtual keyboard presentation and a split virtual keyboard presentation.

FIGS. 3A-B illustrate, in block diagrams, embodiments of different formations for a split virtual keyboard.

FIGS. 4A-C illustrate, in block diagrams, embodiments of different views of a split virtual keyboard.

FIG. 5 illustrates, in a block diagram, one embodiment of a virtual key layout.

FIG. 6 illustrates, in a block diagram, one embodiment of a user profile record.

FIG. 7 illustrates, in a flowchart, one embodiment of a method for creating a user profile.

FIG. 8 illustrates, in a flowchart, one embodiment of a method for displaying a split virtual keyboard to a user.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a portable computer device.

Physical keyboards may typically be located on a desk or solid surface, allowing users to type using the fingers of one or both hands. However, devices incorporating on-screen virtual keyboards may be small, hand-held, and used in informal situations unsuited to physical keyboards. Users may type on the device while sitting, standing, or even lying down. In postures such as these, typical keyboard designs may be difficult to use since one hand is holding the device.

Thus, portable computer devices may offer split on-screen keyboards allowing users to grasp the device with two hands and use thumbs to type. Such split keyboards may not be suitable for some thumb types and thumb sizes. Many physical keyboard layouts employ large or irregular numbers of keys that users become accustomed to using over a period of years. Users may also have a very strong preference tying a specific hand to a specific key, which may carry over to thumb typing. Such preferences may carry over to non-character keys. Users may become disoriented when switching between different keyboard modes.

A portable computer device having a split keyboard with a plurality of size options may increase utility to users. The exact dimensioning of each size offered may be determined through cross-referencing thumb length data with examination of thumb reach for various postures for a range of user's thumbs. A number of layouts may be used to adequately represent the population, resulting in an ergonomically optimal keyboard layout for users regardless of their thumb size. Different options may take into account key size, key spacing, and distance from the base of the screen the side of the screen, referred to as an edge offset.

A split keyboard may be created from a combination of layout templates preserving positional relationships between keys. The key layout data may incorporate the hand dominance of characters. The virtual key layout may provide a consistency of user experience across modalities, regardless of the input language being used. The split keyboard may maintain the same key positions and sizes relative to the corner of the screen regardless of the size of the screen.

Thus, in one embodiment, a split virtual keyboard may be optimized for thumb typing and tailored to an individual user. A processor may determine a virtual key layout for a split virtual keyboard based on a thumb range of a user. A touch screen may display the split virtual keyboard to the user.

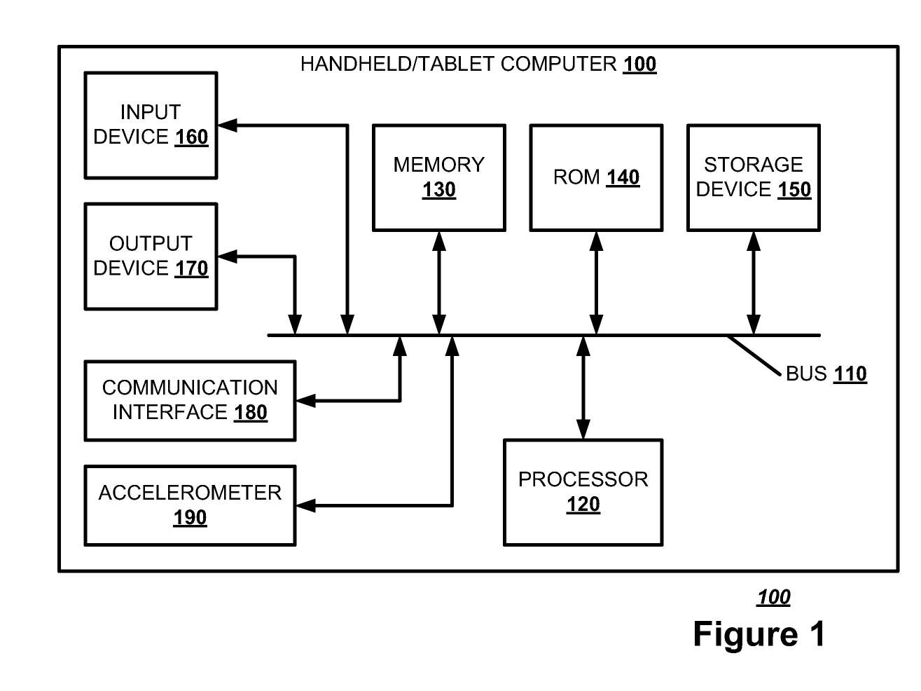

FIG. 1 illustrates a block diagram of an exemplary portable computer device 100. The portable computer device 100 may be a tablet computer or a handheld computer. The portable computer device 100 may combine one or more of hardware, software, firmware, and system-on-a-chip technology to implement a split virtual keyboard. The computing device 100 may include a bus 110, a processor 120, a memory 130, a read only memory (ROM) 140, a storage device 150, an input device 160, an output device 170, a communication interface 180, and an accelerometer 190. The bus 110 may permit communication among the components of the computing device 100.

The processor 120 may include at least one conventional processor or microprocessor that interprets and executes a set of instructions. The memory 130 may be a random access memory (RAM) or another type of dynamic storage device that stores information and instructions for execution by the processor 120. The memory 130 may also store temporary variables or other intermediate information used during execution of instructions by the processor 120. The ROM 140 may include a conventional ROM device or another type of static storage device that stores static information and instructions for the processor 120. The storage device 150 may include any type of tangible machine-readable medium, such as, for example, magnetic or optical recording media and its corresponding drive. The storage device 150 may store a set of instructions detailing a method that when executed by one or more processors cause the one or more processors to perform the method. The storage device 150 may also be a database or a database interface for storing a user profile.

The input device 160 may include one or more conventional mechanisms that permit a user to input information to the computing device 100, such as a virtual keyboard, a touch screen, a mouse, a voice recognition device, a microphone, a headset, etc. The output device 170 may include one or more conventional mechanisms that output information to the user, including a touch screen, a display, a printer, one or more speakers, a headset, or a medium, such as a memory, or a magnetic or optical disk and a corresponding disk drive. The communication interface 180 may include any transceiver-like mechanism that enables processing device 100 to communicate with other devices or networks. The communication interface 180 may include a network interface or a mobile transceiver interface. The communication interface 180 may be a wireless, wired, or optical interface. The accelerometer 190 may be any device used to determine the orientation of the portable computer device 100 relative to the ground or the user, as well as any changes to that orientation.

The portable computer device 100 may perform such functions in response to processor 120 executing sequences of instructions contained in a computer-readable medium, such as, for example, the memory 130, a magnetic disk, or an optical disk. Such instructions may be read into the memory 130 from another computer-readable medium, such as the storage device 150, or from a separate device via the communication interface 180.

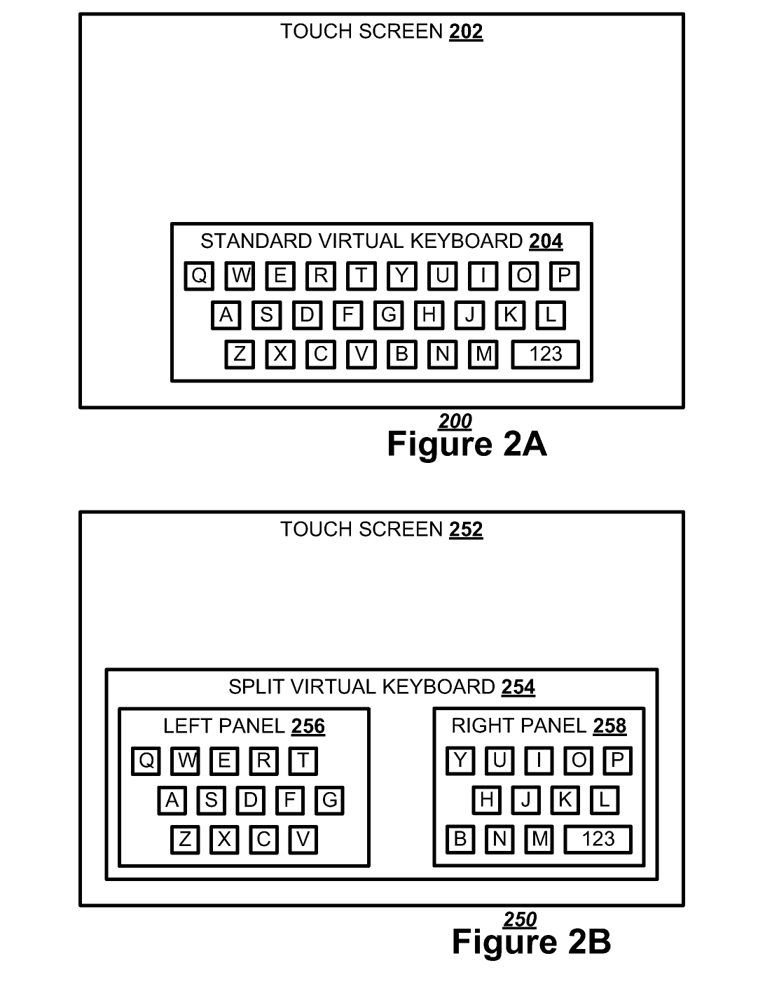

As the keyboard of a portable computer device with a touch screen may be virtual, the virtual keyboard may be arranged in a number of configurations. FIG. 2A illustrates, in a block diagram, one embodiment of a standard virtual keyboard presentation 200. In a standard virtual keyboard presentation 200, a portable computer device 100 may have a touch screen 202 displaying a standard virtual keyboard 204. The standard virtual keyboard 204 may have a series of alphabetical keys in a single key block arranged in a QWERTY formation. The standard virtual keyboard 204 may be an alphabetical view, having primarily alphabetical keys with potentially some number or symbol keys. The standard virtual keyboard 204 may have a toggle key that allows a user to select between an alphabetical view and other views.

FIG. 2B illustrates, in a block diagram, one embodiment of a split virtual keyboard presentation 250. In a split virtual keyboard presentation 250, a portable computer device 100 may have a touch screen 252 displaying a split virtual keyboard 254. The split virtual keyboard 254 may have a series of alphabetical keys in an overall QWERTY formation. The split virtual keyboard 254 may divide the keys into two groups organized into a left panel 256 of keys and a right panel 258 of keys. Alternately, the split virtual keyboard 254 may divide the keys into three or more groups. For example, the split virtual keyboard 254 may have a middle panel to facilitate finger typing. A panel is a sub-grouping of keys, and may or may not be a display object shown on the touch screen 252. The left panel 256 may be located in the lower left corner of the touch screen 252, and the right panel 258 may be located in the lower right corner of the touch screen 252. The split virtual keyboard 254 may be an alphabetical view, having primarily alphabetical keys with potentially some number or symbol keys. The split virtual keyboard 254 may have a toggle key that allows a user to select between an alphabetical view and other views.

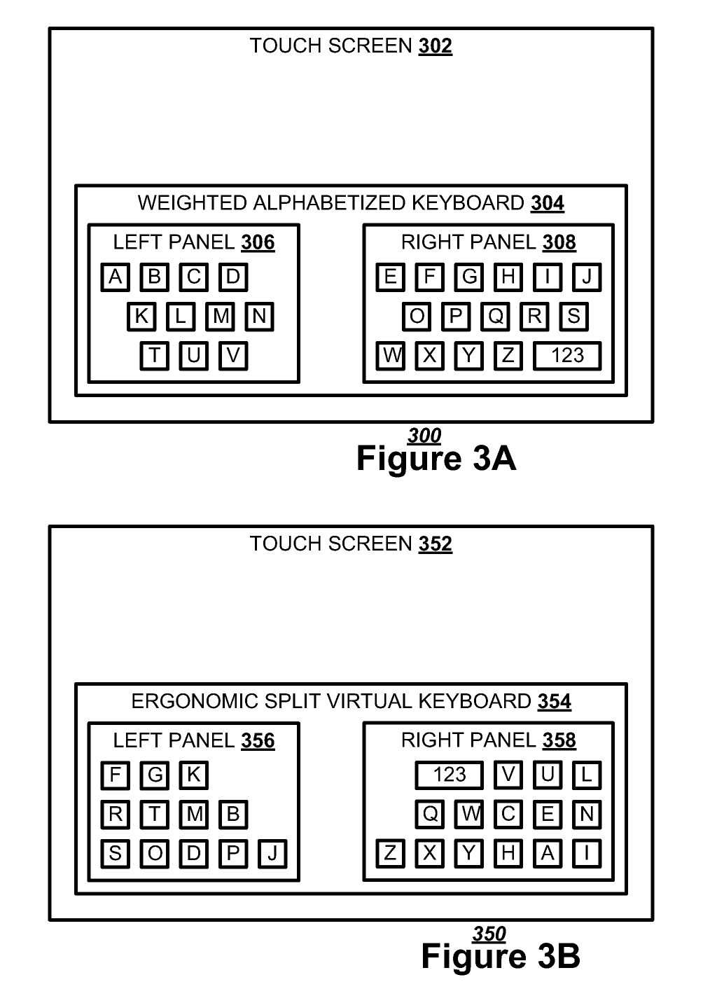

The QWERTY formation is a legacy of physical typewriters that had to slow down key use to prevent jamming. As the virtual keyboard has no such concerns, the keys may be rearranged to a more efficient design. FIG. 3A illustrates, in a block diagram, one embodiment of an alphabetized split virtual keyboard presentation 300. In an alphabetized split virtual keyboard presentation 300, a portable computer device 100 may have a touch screen 302 displaying a split virtual keyboard 304. The split virtual keyboard 304 may divide the keys into two groups organized into a left panel 306 of keys and a right panel 308 of keys. The left panel 306 may be located in the lower left corner of the touch screen 302, and the right panel 308 may be located in the lower right corner of the touch screen 302. The split virtual keyboard 304 may be an alphabetical view, having primarily alphabetical keys with potentially some number or symbol keys. The split virtual keyboard 304 may have a toggle key that allows a user to select between an alphabetical view and other views. The split virtual keyboard 304 may have a series of alphabetical keys in an alphabetized formation, placing the keys in alphabetical order. Additionally, the split virtual key board 304 may be weighted towards the dominant hand of the user. For example, if the user is right handed, the split virtual keyboard may place more keys in the right panel 308. Alternatively, if the user is left handed, the split virtual keyboard may place more keys in the left panel 306.

FIG. 3B illustrates, in a block diagram, one embodiment of an ergonomic split virtual keyboard presentation 350. In an ergonomic split virtual keyboard presentation 350, a portable computer device 100 may have a touch screen 352 displaying a split virtual keyboard 354. The split virtual keyboard 354 may divide the keys into two groups organized into a left panel 356 of keys and a right panel 358 of keys. The left panel 356 may be located in the lower left corner of the touch screen 352, and the right panel 358 may be located in the lower right corner of the touch screen 352. The split virtual keyboard 354 may be an alphabetical view, having primarily alphabetical keys with potentially some number or symbol keys. The split virtual keyboard 354 may have a toggle key that allows a user to select between an alphabetical view and other views. The split virtual keyboard 354 may have a series of alphabetical keys in an ergonomic formation. For example, the keys may be arranged so that the most commonly used keys are placed to be closest to a corner of the touch screen 352 for ease of access by the user. Alternately, the most commonly used keys may be placed in the natural resting position of the thumb of the user.

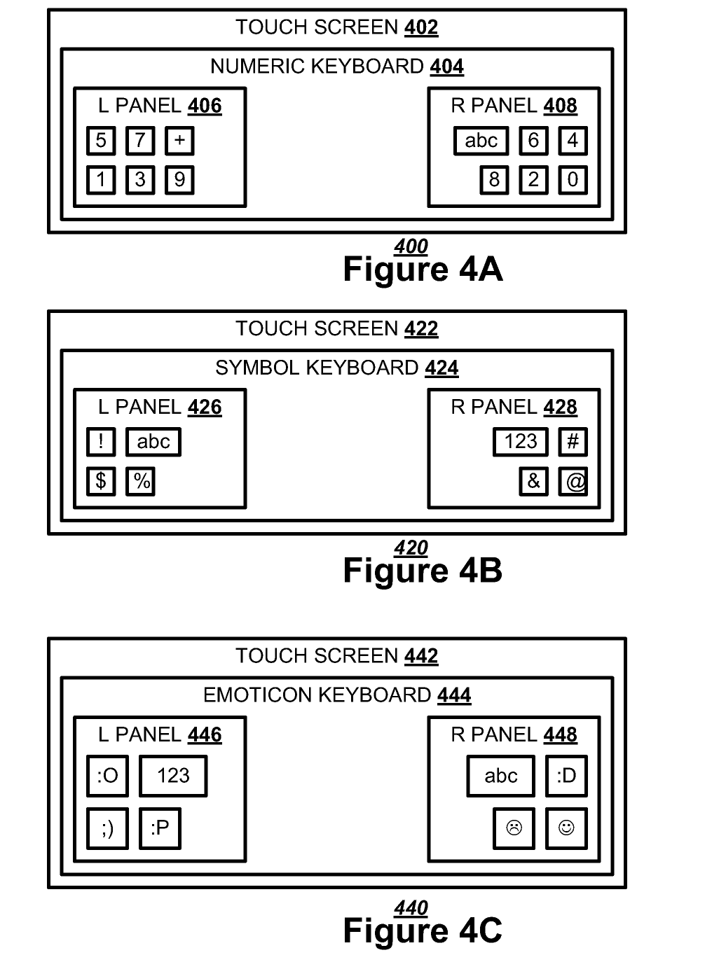

A split virtual keyboard may be a full keyboard containing alphabetical keys, number keys, symbol keys, and other keys. Alternatively, a split virtual keyboard may be separated into a set of one or more views, with a toggle keys to move between views. Each view may focus on a specific type of key, although other types of keys may be present in each view. FIG. 4A illustrates, in a block diagram, one embodiment of a numeric view presentation 400. In a numeric view presentation 400, a portable computer device 100 may have a touch screen 402 displaying a numeric view of a split virtual keyboard 404. The split virtual keyboard 404 may divide the keys into two groups organized into a left panel 406 of keys and a right panel 408 of keys. The left panel 406 may be located in the lower left corner of the touch screen 402, and the right panel 408 may be located in the lower right corner of the touch screen 402. The split virtual keyboard 404 may be a numerical view, having primarily number keys with potentially some alphabetical keys, symbol keys, or other keys. The split virtual keyboard 404 may have a toggle key that allows a user to select between a numerical view and other views.

FIG. 4B illustrates, in a block diagram, one embodiment of a symbol view presentation 420 of a split virtual keyboard. In a symbol view presentation 420, a portable computer device 100 may have a touch screen 422 displaying a symbol view of a split virtual keyboard 424. The split virtual keyboard 424 may divide the keys into two groups organized into a left panel 426 of keys and a right panel 428 of keys. The left panel 426 may be located in the lower left corner of the touch screen 422, and the right panel 428 may be located in the lower right corner of the touch screen 422. The split virtual keyboard 424 may be a symbol view, having primarily symbol keys with potentially some alphabetical keys, number keys, or other keys. The split virtual keyboard 424 may have a toggle key that allows a user to select between a symbol view and other views.

FIG. 4C illustrates, in a block diagram, one embodiment of an emoticon view presentation 440 of a split virtual keyboard. An emoticon is a symbol or combination of punctuation and letters that indicate the emotion or tone of a user. In an emoticon view presentation 440, a portable computer device 100 may have a touch screen 442 displaying an emoticon of a split virtual keyboard 444. The split virtual keyboard 444 may divide the keys into two groups organized into a left panel 446 of keys and a right panel 448 of keys. The left panel 446 may be located in the lower left corner of the touch screen 442, and the right panel 448 may be located in the lower right corner of the touch screen 444. The split virtual keyboard 444 may be an emoticon view, having primarily emoticon keys with potentially some alphabetical keys, number keys, or other keys. The split virtual keyboard 444 may have a toggle key that allows a user to select between an emoticon view and other views.

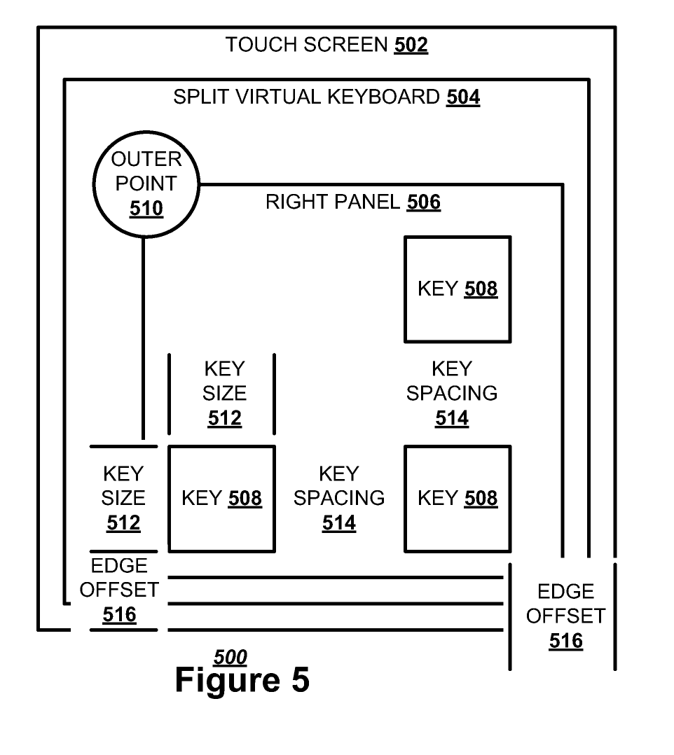

The portable computer device 100 may adjust the virtual key layout based on a thumb range of a user to improve the usability of split virtual keyboard. The thumb range is the area accessible by the thumbs of the user when holding the portable computer device 100. Alternately, the portable computer device 100 may adjust the virtual key layout based on user input indicating a user preference. FIG. 5 illustrates, in a block diagram, one embodiment of a virtual key layout 500. A touch screen 502 may display a split virtual keyboard 504 having a right panel 506 organizing a set of keys 508 in a virtual key layout 500. While a square key 508 is shown, the key may be other shapes, such as circular or conic, that allow for easy selection by a thumb.

The touch screen 502 may register a user drag at an outer point 510 of the right panel 506, indicating that the user may want to change the size or shape of the virtual key layout 500. A user drag is the movement of a user digit across the surface of the touch screen to indicate a user input. Aspects of the key layout that may be adjusted to improve the usability of the split virtual keyboard 504 may include a key size 512, a key spacing 514, or an edge offset 516. The key size 512 is the size of the keys 510, whether measured by a length and width, by a diameter, by a circumference, by area, or by other means. The key spacing 514 is the space between the keys 510. The edge offset 516 is the distance from the edge of the touch screen 502 to a key 510. The actual arrangement of the keys may be adjusted based on the use pattern of the user.

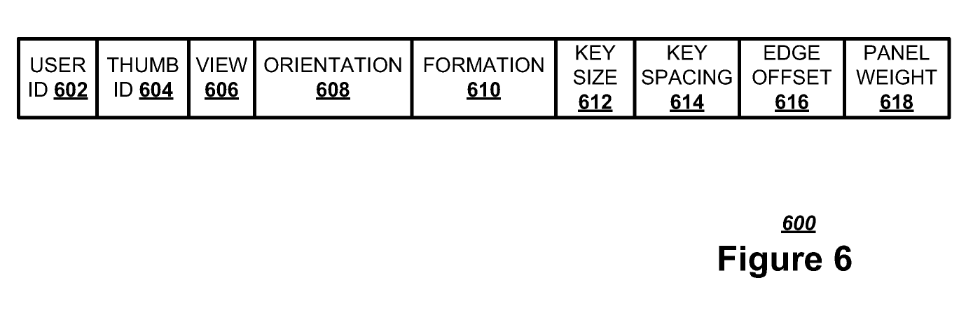

The portable computer device 100 may associate a virtual key layout with a user profile of the user, so that when the user begins using the portable computer device 100, the portable computer device 100 displays the preferred virtual key layout to the user. FIG. 6 illustrates, in a block diagram, one embodiment of a user profile record 600. The user profile record 600 may have a user identifier (ID) 602 to indicate the user. The user profile record 600 may have a thumb identifier 604. The thumb identifier 604 is a characteristic of the thumb of the user that may be used to identify the user. The thumb identifier 604 may be a thumbprint for specifically identifying the user, or a thumb size for differentiating the user from other individuals that may be using the portable computer device 100. For example, the thumb size of a parent may be different from the thumb size of a child. The user identifier 602 may be the thumb identifier 604.

The user may have different virtual key layouts depending on the view and the orientation. The user profile record 600 may have a view field 606 and an orientation field 608. The user profile record 600 may have multiple virtual key layouts, representing each view and orientation. The view field 606 may indicate if the split virtual keyboard is an alphabetical view, a numerical view, a symbol view, an emoticon view, or other view. The orientation field 608 may indicate the orientation of the portable computer device 100. For example, the orientation may be landscape or portrait. Orientation may further indicate the angle the portable computer device 100 is to horizontal. Thus, the split virtual keyboard may have a different virtual key layout depending on whether the user is holding the portable computer device 100 while sitting, standing, or lying down.

The user profile record 600 may have a series of fields describing the virtual key layout. The user profile record 600 may have a formation field 610, a key size field 612, a key spacing field 614, an edge offset field 616, and a panel weight field 618. The formation field 610 describes whether the keyboard is in a QWERTY formation, an alphabetized formation, an ergonomic formation, or an alternate formation. The key size field 612 may describe the size of keys in the split virtual keyboard. The key spacing field 614 may describe the spacing of the keys in the split virtual keyboard. The edge offset field 616 may describe the distance of the keys from the edge of the touch screen. The panel weight field 618 may describe the distribution of the keys between the two panels. The panels may be weighted based on a hand dominance of the user. For example, a left-handed user may have more keys in the left panel than the right panel, just as a right-handed user may have more keys in the right panel than the left panel.

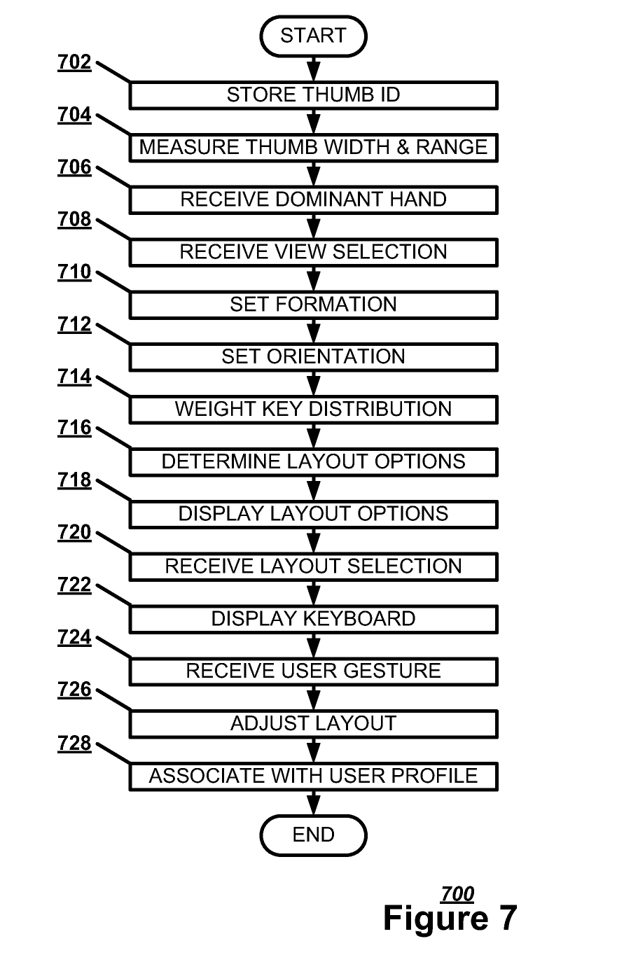

The user may create a user profile record 600 the first time the portable computer device 100 is used, the first time a split virtual keyboard view is used, or the first time an orientation for the portable computer device is used. The user may make adjustments to the split virtual keyboard, and have those adjustments stored in the user profile record 600. FIG. 7 illustrates, in a flowchart, one embodiment of a method 700 for creating a user profile 600. The portable computer device 100 may store a thumb identifier identifying the user (Block 702). The portable computer device 100 may measure a thumb width and thumb range (Block 704). The thumb width may be measured by having the user press a thumb on the touch screen. The thumb range may be measured by having the user extend the thumb to its farthest extent at a forty-five degree angle while gripping the portable computer device 100. Alternately, the user may perform a circular sweep with the thumb while gripping the portable computer device. The portable computer device 100 may receive from the user an entry indicating the dominant hand of the user (Block 706).

The portable computer device 100 may receive a keyboard view selection of at least one of an alphabetical view, a numerical view, a symbol view, or an emoticon view based on user input (Block 708). The portable computer device 100 may set a split virtual keyboard formation to at least one of a QWERTY formation, an alphabetized formation, or an ergonomic formation based on user input (Block 710). The portable computer device 100 may set an orientation for the user profile record 600 (Block 712).

The portable computer device 100 may weight a key distribution between panels of the split virtual keyboard based on a hand dominance of the user (Block 714). The portable computer device 100 may determine one or more virtual key layout options for the split virtual keyboard based on the thumb range and thumb size of the user (Block 716). The portable computer device 100 may display the virtual key layout options for the split virtual keyboard to the user (Block 718). The portable computer device 100 may receive a virtual key layout selection from the user (Block 720). The portable computer device 100 may display the split virtual keyboard to the user on a touch screen (Block 722).

The portable computer device 100 may detect a user gesture indicating a virtual key layout adjustment (Block 724). A user gesture may be a user drag of an outer point 510 or a user pinch of two points on the touch screen indicating the user wants to adjust size and placement of the split virtual keyboard. Alternately, the portable computer device 100 may receive user input via a set of buttons indicating various default split virtual keyboard sizes, such as small, medium, or large. The default split virtual keyboard sizes may be based on a statistical analysis of user thumb use patterns. The portable computer device 100 may adjust the virtual key layout for the split virtual keyboard based on the thumb range of the user (Block 726). The portable computer device 100 may adjust the virtual key layout based on at least one of a thumb range, a thumb size, or a grip. The portable computer device 100 may adjust the virtual key layout by adjusting at least one of a key size, a key spacing, or an edge offset of the split virtual keyboard. The portable computer device 100 may associate the virtual key layout with the user profile 600 of the user (Block 728).

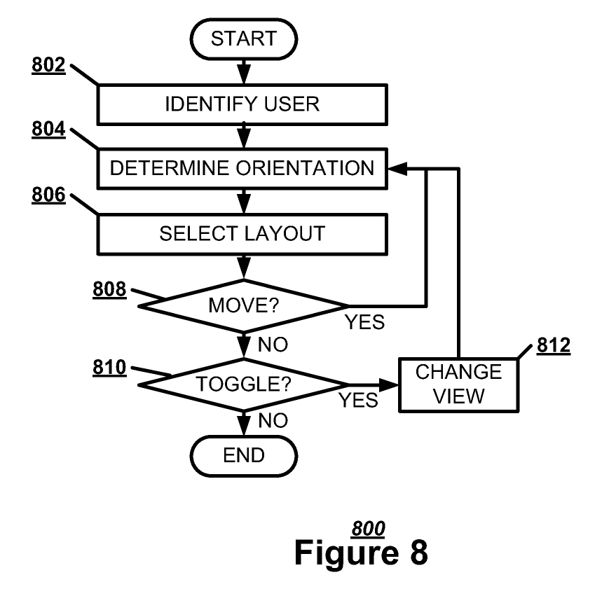

The next time that the user uses the portable computer device 100, the portable computer device 100 may use the user profile to provide a personalized split virtual keyboard. FIG. 8 illustrates, in a flowchart, one embodiment of a method 800 for displaying a split virtual keyboard to a user. The portable computer device 100 may identify the user based on a thumb identifier (Block 802). The portable computer device 100 may determine an orientation of the portable computer device 100 (Block 804). The portable computer device 100 may select a virtual key layout for a split virtual keyboard based on a user profile indicating a thumb range of the user and based on the orientation (Block 806). If the orientation of the portable computer device 100 moves (Block 808), the portable computer device 100 may determine the new orientation (Block 804) and select a new virtual key layout (Block 806). If the user toggles to a different split virtual keyboard view (Block 810), the portable computer device 100 may change to the new split virtual keyboard view (Block 812). The portable computer device 100 may determine the new orientation (Block 804) and select a new virtual key layout (Block 806).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include non-transitory computer-readable storage media for carrying or having computer-executable instructions or data structures stored thereon. Such non-transitory computer-readable storage media may be any available media that can be accessed by a general purpose or special purpose computer. By way of example, and not limitation, such non-transitory computer-readable storage media can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
determining a virtual key layout for a split virtual keyboard based on a thumb range of a user; and
displaying the split virtual keyboard to the user on a touch screen of a portable computer device.

2. The method of claim 1, further comprising:
associating the virtual key layout with a user profile of the user.

3. The method of claim 1, further comprising:
identifying the user based on a thumb identifier.

4. The method of claim 1, further comprising:
receiving a virtual key layout selection from the user.

5. The method of claim 1, further comprising:
detecting a user gesture indicating a virtual key layout adjustment.

6. The method of claim 1, further comprising:
adjusting at least one of a key size, a key spacing, and an edge offset of the split virtual keyboard.

7. The method of claim 1, further comprising:
adjusting the virtual key layout based on at least one of a thumb range, a thumb size, and a grip.

8. The method of claim 1, further comprising:
receiving a keyboard view selection of at least one of an alphabetical view, a numerical view, a symbol view, and an emoticon view.

9. The method of claim 1, further comprising:
setting a split virtual keyboard formation to at least one of a QWERTY formation, an alphabetized formation, and an ergonomic formation.

10. The method of claim 1, further comprising:
weighting a key distribution between panels of the split virtual keyboard based on a hand dominance of the user.

11. The method of claim 1, further comprising:
determining an orientation of the portable computer device; and
selecting the virtual key layout based on the orientation.

12. The method of claim 1, wherein the portable computer device is at least one of a tablet computer and a handheld computer.

13. A tangible machine-readable medium having a set of instructions detailing a method stored thereon that when executed by one or more processors cause the one or more processors to perform the method, the method comprising:
displaying a split virtual keyboard to a user on a touch screen of a portable computer device, and
adjusting a virtual key layout for the split virtual keyboard based on a thumb range of the user.

14. The tangible machine-readable medium of claim 13, wherein the method further comprises:
associating the virtual key layout with a user profile of the user.

15. The tangible machine-readable medium of claim 13, wherein the method further comprises:
receiving a virtual key layout selection from the user.

16. The tangible machine-readable medium of claim 13, wherein the method further comprises:
adjusting at least one of a key size, a key spacing, and an edge offset of the split virtual keyboard.

17. The tangible machine-readable medium of claim 13, wherein the method further comprises:
adjusting the virtual key layout based on at least one of a thumb size and a grip.

18. The tangible machine-readable medium of claim 13, wherein the method further comprises:
determining an orientation of the portable computer device; and
selecting the virtual key layout based on the orientation.

19. A portable computer device, comprising:
a processor that determines a virtual key layout option for a split virtual keyboard based on a thumb range of a user; and
a touch screen that displays the split virtual keyboard to the user and receives a virtual key layout selection from the user.

20. The portable computer device of claim 19, wherein the touch display screen detects a user gesture to indicate the virtual key layout adjustment.
